(19) United States
(12) Patent Application Publication
(10) Pub. No.: US 2025/0022626 A1
(43) Pub. Date: Jan. 16, 2025

(54) CONTAINER FOR RADIOACTIVE WASTE

(71) Applicant: INGECID, S.L., SANTANDER (CANTABRIA) (ES)

(72) Inventors: Jokin RICO ARENAL, SANTANDER (CANTABRIA) (ES); Diego RODRÍGUEZ SAEZ, SANTANDER (CANTABRIA) (ES)

(21) Appl. No.: 18/707,587

(22) PCT Filed: Oct. 28, 2022
(86) PCT No.: PCT/ES2022/070700

§ 371 Date: May 5, 2024

(30) Foreign Application Priority Data
Nov. 4, 2021 (ES) P202131037

(51) Int. Cl. G21F 5/10; G21F 1/04; G21F 1/08; G21F 5/008; G21F 5/08

(52) U.S. Cl. CPC G21F 5/10; G21F 1/04; G21F 1/08; G21F 5/008; G21F 5/08

(57) ABSTRACT

A radioactive waste container, suitable for housing a canister or rack (C) containing the waste constituting a source of radioactive emission; and comprising: an inner containment barrier (1) against photon radiation, delimiting a housing for the canister or rack (C) containing the radioactive waste to be stored and comprising: an inner cylindrical steel ferrule (11), a base (12) and a lid (13); an outer containment barrier (2) against photon radiation, forming the outer surface of the container (10) and comprising: an outer cylindrical steel ferrule (21), a base (22) and a lid (23) and, an intermediate concrete layer (3) arranged between said inner (11) and outer (21) ferrules and forming a shield against neutron radiation.

### TECHNICAL FIELD

The present invention relates to a container applicable to the storage of radioactive waste and, especially, of spent fuel from nuclear power plants.

### STATE OF THE ART

In the state of the art related to the indicated sector, various containers are known that can be generally classified into two types: concrete containers and metal containers. Such containers are useful to protect or envelop the waste canister to be protected or the rack where the elements involved in the spent fuel storage are housed.

In metal containers different layers of different materials are used, having a thicker layer of steel, usually forged, between 200 and 300 mm. thick, with high mechanical abilities, whose main critical function is the containment against mechanical stresses such as impacts, seismic stresses or others.

From the point of view of radiation shielding, this layer of forged steel, which given its high density has a high shielding ability against photonic radiation, must be complemented with a shielding against neutron radiation, against which steel does not provide sufficient efficiency.

This outer shield, usually some type of neutron poison, is arranged in an outer layer, surrounding the steel layer, and in turn is protected externally with a metal structure to prevent it from being damaged during handling.

In patent U.S. Pat. No. 8,548,112, HOLTEC INTERNATIONAL a constructive alternative is disclosed, wherein the metallic structure of the container has holes, in a staggered way, to introduce a neutron radiation absorbing material, such as a solidifying liquid or other materials, to be distributed in the different modules that make up the surrounding part of the container.

In this background, the main layer of forged steel has perforations to introduce neutron shielding, to later be assembled around a central ferrule, also made of steel.

In concrete containers, the layer of this material has the main different safety functions. In these containers, the concrete layer usually has thicknesses from 500 mm. to 1000 mm. Due to the lower strengths that the concrete has to absorb impacts, seismic or other stresses, and because to be as efficient as steel for photon radiation in which density shielding is required, the ratio of densities between steel and conventional concrete, of 3 or 4 times, makes it necessary to increase the thickness of concrete in that proportion to equal the abilities of steel. The concrete layer can be combined with other metal layers as ferrules that have the function of being used as a formwork or protection for the concrete, but do not have the main function of shielding and structural protection that the concrete has.

One of the advantages of the metal container is that it does not require additional ventilation, since the metal evacuates heat more efficiently than concrete and, additionally, has a lower thickness than concrete. Concrete containers require additional heat evacuation systems with recurring maintenance.

Also known are documents U.S. Pat. No. 7,786,456 and US 2010/0272225, HOLTEC INTERNATIONAL, which disclose containers in which concrete is combined with metal ferrules in the container enclosure.

Document U.S. Pat. No. 6,064,710 further explains this (metal+concrete) combination in the structure of the container that houses the canister. In this patent, the concrete layer is poured by traditional methods, but the thickness of the metal layers of the ferrules and the concrete layer are the same as in the state of the art, and no ratio of thicknesses that are relevant in the present invention to achieve the objectives set forth is claimed.

### SUMMARY OF THE INVENTION

The invention relates to a container for radioactive waste, specifically intended to house a canister or a rack containing the radioactive waste constituting a source of radioactive emission.

The container of the invention comprises:
an inner containment barrier against photon radiation, delimiting a housing for the canister or the rack for the radioactive waste to be stored, and comprising: a cylindrical inner steel ferrule, a base and a lid;
a containment barrier against photon radiation, forming the outer surface of the container, and comprising: a cylindrical outer steel ferrule, a base and a lid, and
an intermediate concrete layer arranged between said inner and outer ferrules, and forming a shield against neutron radiation.

The inner and outer ferrules are concentric and delimit an intermediate cavity therebetween in which the intermediate concrete layer is housed.

Said inner and outer ferrules, and the intermediate concrete layer arranged between them, have the same or similar thicknesses, which provides an optimization or balance between the three layers: outer ferrule, concrete pieces, and inner ferrule.

According to an embodiment of the invention, the intermediate concrete layer is formed by the concrete pieces having an annular cylinder arc configuration and which can have all their ends flat, or at least one tongued or grooved end for being coupled with an adjacent concrete piece. Therefore, the concrete pieces arranged between the two metal ferrules may have opposite coupling tongued and grooved ends, which facilitate their assembly and which, once assembled, fill said intermediate cavity.

According to the invention, the concrete pieces may comprise a metal envelope that, in the mounting position of the container, contacts the inner and outer ferrules, forming a thermal bridge that facilitates heat dissipation, since the metal has properties that promote this heat evacuation with a much higher speed than concrete.

Therefore, such concrete pieces provide high versatility in the design of the container.

According to the invention, the intermediate concrete layer can incorporate in its composition various materials that allow an easy adaptation of the same to complement the shielding ability of the surrounding steel layers and adapt to the specific needs of the specific application where it is intended to be used, optimizing production costs and complying with safety requirements.

Specifically, and for this purpose, it is envisaged that said intermediate concrete layer may include in its composition any of the following materials:
high-efficiency materials in neutron radiation shielding;
materials with high density and photon shielding ability;
materials with high thermal conductivity and heat dissipation ability, and/or
materials with high mechanical strength.

According to another embodiment, the intermediate concrete layer is made by a concrete block formed “in situ” by a mass of concrete poured between the inner and outer ferrules; said ferrules comprising metal connectors welded to said ferrules on their opposite surfaces and embedded in the concrete block, being used as anchoring elements between the poured concrete and the steel of the side ferrules, and since the ferrules and the connectors are metallic, they can work together and facilitate the transmission of heat.

According to the invention, between the bases and between the lids closing the containment barriers at the bottom and top, inside and outside, the container comprises at least one radiation shielding layer formed of: concrete, steel, lead or any other material suitable for radiation shielding depending on the type of residue contained in the canister or rack.

Advantageously, the container, between the bases and/or between the closing lids of the containment barriers, inside and outside, has elastic impact absorption elements that minimize the risk of damage to the canister in the event that the container receives an impact.

With the aforementioned structure, this container meets all the safety requirements of this type of containers with the best possible shielding of the container against the emission of radiation from the canister or rack, thanks to the nature of the materials with which the enclosures, bases and lids of the container are made, and the way these materials are arranged in the container.

The steel outer and inner ferrules ensure the provision of structural safety to the container and, together with the layer of concrete arranged between said ferrules, provide a high radiation shielding, optimizing the thicknesses of the concrete and the thicknesses of the ferrules.

This container meets the following objectives:
It is efficient in protecting against different radiations from radioactive waste contained inside the canister or rack.
It simplifies the manufacture of the container, achieving a standardization and reduction of production costs, maintaining all the inherent safety performances.

Structurally, this container behaves like a metal container, since the possible impacts and mechanical stresses are withstood by the metal ferrules.

Comparatively, given its structure and composition, this container has a smaller diameter than a concrete container, which provides an additional advantage by allowing a better use of the space within the storage facility and a lower weight, making the technical means for its handling also less restrictive than in the case of conventional concrete containers.

Functionally, from the thermal point of view, it can also work as a metal container because, unlike concrete containers, it does not require an additional ventilation system. In this way, it exploits the advantages that metal containers have but incorporating a concrete block, or concrete pieces easily coupled to each other, for shielding against certain types of radiation.

### BRIEF DESCRIPTION OF THE CONTENTS OF THE DRAWINGS

In order to complement the description that is being carried out and with the purpose of facilitating the understanding of the characteristics of the invention, the present description is accompanied by a set of drawings wherein, by way of a non-limiting example, the following has been represented:

FIG. 1 shows a perspective view of one embodiment example of the radioactive waste container according to the invention.

FIG. 2 shows a rear perspective view of the container of the previous figure sectioned along a vertical plane.

FIG. 3 shows an enlarged detail in FIG. 2.

FIG. 4 shows a top plan view of the radioactive waste container of the previous figures sectioned by a horizontal plane and in which the intermediate concrete layer is made by prefabricated concrete pieces.

FIG. 5 shows a perspective view of an example embodiment of one of the concrete pieces intended to be housed between the inner and outer ferrules of the container, provided in this case with flat ends.

FIG. 6 shows a perspective view of an embodiment variant of one of the concrete piece, with the ends tongued and grooved.

FIG. 7 shows an elevation view of an embodiment variant of the container, sectioned by a horizontal plane, in which the intermediate concrete layer is made by a single piece of concrete, formed “in situ” by pouring concrete between the inner and outer ferrules.

FIG. 8 shows a sectioned detail in elevation of a lower portion of the container of the invention provided with elastic cushioning elements between the bases of the inner and outer containment barriers.

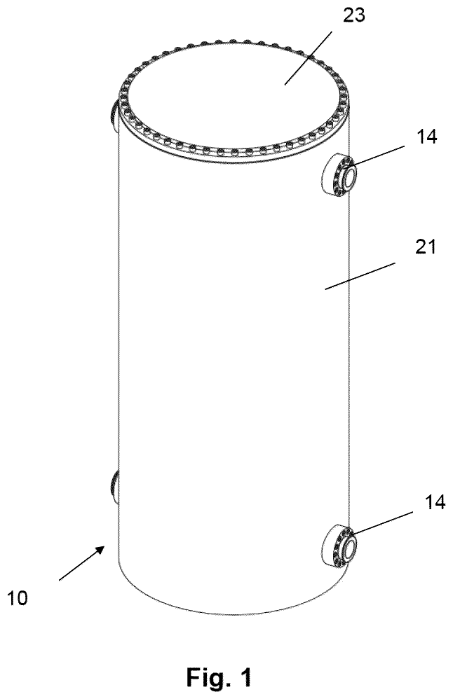

### DETAILED EXPLANATION OF EMBODIMENTS OF THE INVENTION

In the example embodiment shown in the accompanying figures, the radioactive waste container object of the invention, collectively referred to as (10), comprises:
an inner containment barrier (1) formed by an inner cylindrical steel ferrule (11), a base (12) and a lid (13);
an outer containment barrier (2) formed by an outer cylindrical steel ferrule (21), a base (22) and a lid (23), and
an intermediate concrete layer (3) arranged between said inner and outer ferrules.

The container (10) externally comprises, for gripping and handling, trunnions (14) fixed to the outer ferrule (21) by bolts (15).

The inner (1) and outer (2) containment barriers respectively make up the inner and outer surfaces of the container (10).

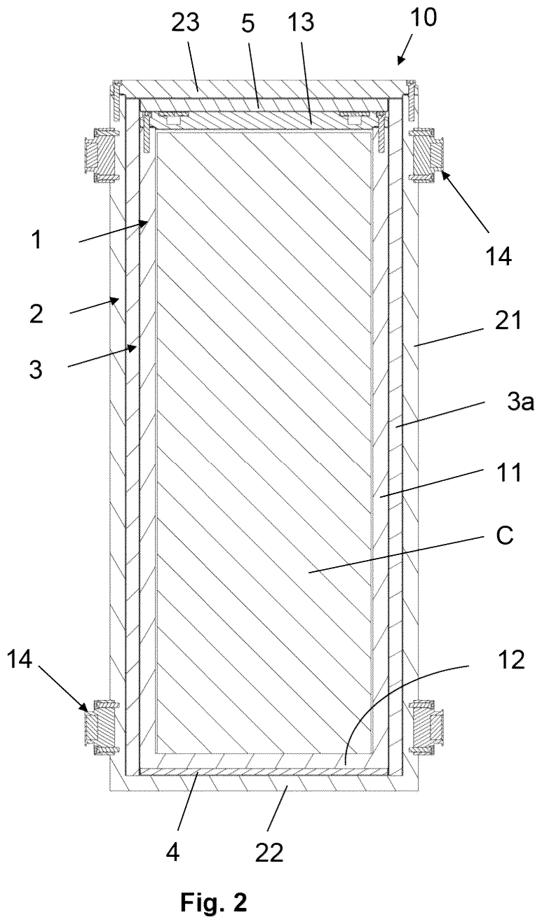

In the example shown in FIG. 2, the container (10) comprises between the bases (12, 22), which close at the bottom the ferrules of the containment barriers, a radiation shielding layer (4); and between the lids (13, 23), which close at the top the inner (1) and outer (2) containment barriers, at least one shielding layer (5). Said shielding layers (4, 5) may be made of: concrete, steel, lead or any other material suitable for radiation shielding.

The inner ferrule (11) together with the base (12) and the lid (13) of the inner containment barrier (1) delimit a housing for the canister or rack (C) containing the radioactive waste to be stored.

The inner lid (13) comprises a drain and vent system (19) for operating the fuel.

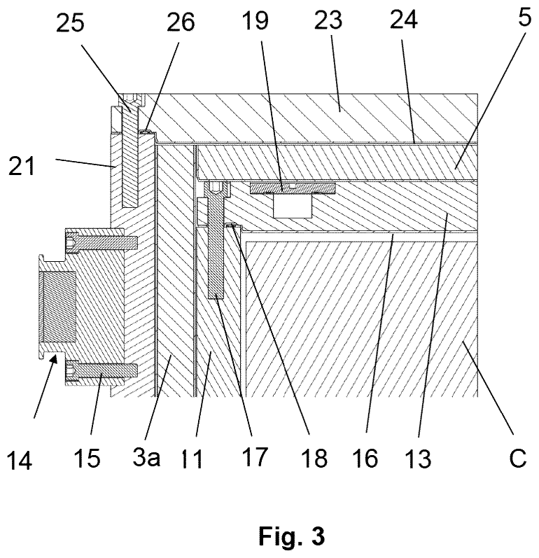

As can be seen in the detail in FIG. 3, the lid (13) of the inner containment barrier (1) comprises on its inner face a metal sheet (16), attached to said lid (13), to facilitate the assembly and seating thereof on the inner ferrule (11).

Said lid (13) is fixed to the inner ferrule by means of bolts (17), with a pressure sealing gasket (18) being arranged therebetween.

Similarly, the lid (23) of the outer containment barrier (2) has on its inner face a metal sheet (24) for mounting and seating on the outer ferrule (21), to which it is fixed, with a pressure sealing gasket (26) placed therebetween, by means of bolts (25).

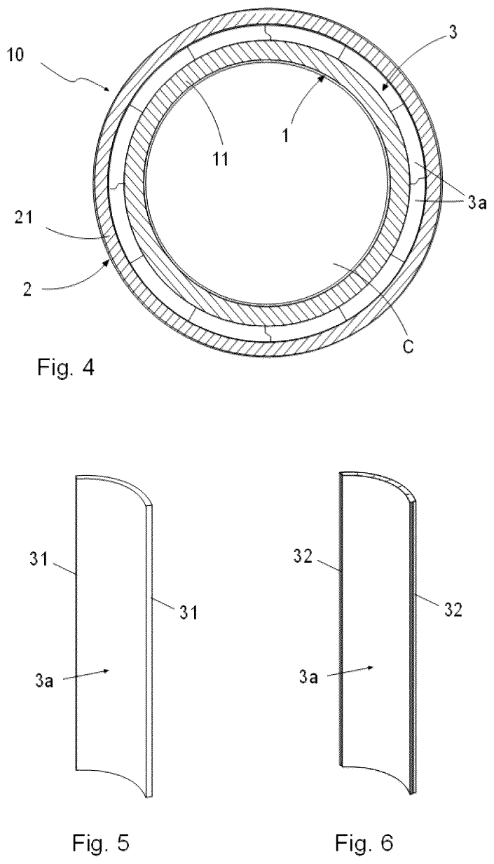

In FIG. 4, said inner and outer ferrules (11, 21) are concentric and delimit an intermediate cavity in which the intermediate concrete layer (3) is housed.

The inner ferrule (11), the outer ferrule (21) and the intermediate concrete layer (3), located in the intermediate cavity, have the same or similar thicknesses, the set thereof forming a container (10) of a considerably smaller thickness than the concrete containers.

In the embodiment shown in FIG. 4, the intermediate concrete layer (3) is made up of concrete pieces (3a) which, as shown in FIGS. 5 and 6, have an annular cylinder arc configuration.

Said concrete pieces (3a) can have flat ends (31) as shown in FIG. 5, or tongued and grooved ends (32) as shown in FIG. 6, for their coupling with another analogous concrete piece, said concrete pieces (3a) covering in any case the entire cavity defined between the inner (11) and outer (21) ferrules, as shown in FIG. 4.

The steel inner (11) and outer (21) ferrules provide the container (10) with a shield against photon radiation; while the intermediate concrete layer (3) provides a shield against neutron radiation.

Advantageously, the concrete pieces (3a) considerably facilitate the construction of the container (10), since said construction requires only the orderly placement of the different constituent parts of the inner (1) and outer (2) containment barriers, and the insertion between their respective ferrules (11, 21) of the aforementioned concrete pieces (3a).

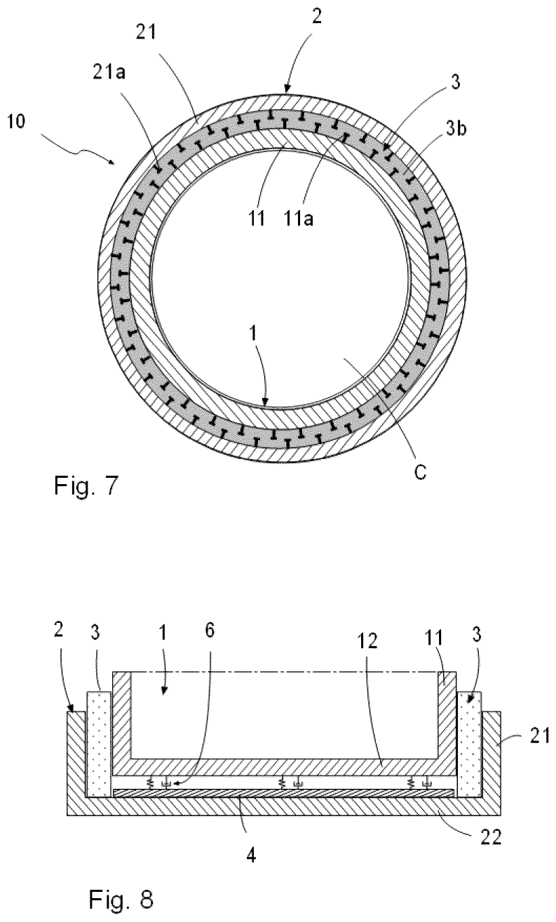

In the embodiment variant shown in FIG. 7, the intermediate concrete layer (3) is made by a concrete block (3b) as an annular cylinder, shaped “in situ” with a mass of concrete poured between the inner (11) and outer (21) ferrules; said ferrules (11, 21) comprising metal connectors (11a, 21a) welded to said ferrules and embedded in the concrete piece (3b) on their opposite surfaces.

Regardless of whether the intermediate concrete layer (3) is formed by means of several pieces of concrete (3a) or by means of a concrete block (3b) made “in situ”, it is envisaged incorporating suitable materials into the concrete mass used for its manufacturing to vary its properties and achieve different effects, such as: increasing the shielding offered by said intermediate concrete layer (3) against neutron radiation, increasing its density and photon shielding ability, increasing its heat dissipation ability, or increasing its mechanical strength.

The materials to be incorporated into the concrete mass, to increase the shielding offered by the intermediate concrete layer (3) against neutron radiation, are elements of high efficiency against this type of radiation, specifically aggregates with high content of hydrogen, carbon or boron, such as colemanite, or a mixture thereof with other limestone aggregates.

In one embodiment of the invention, to increase the density and photon shielding ability, the intermediate concrete layer (3) includes in its composition magnetite, barite or other high density aggregates.

To increase thermal conductivity and heat dissipation ability, the intermediate concrete layer (3) includes in its composition aggregates with a high content of iron or other conductive minerals.

Preferably, to increase the mechanical strength of the intermediate concrete layer (3), it includes in its composition aggregates of high mechanical strength, such as magnetite, barite or the like.

In the example embodiment shown in FIG. 8, the container comprises between the bases (12, 22) of the containment bars (1, 2) elastic elements (6) for cushioning and absorption of possible impacts.

Once the nature of the invention as well as an example of preferred embodiment have been sufficiently described, it is stated for all pertinent purposes that the materials, form, size and arrangement of the elements described are susceptible to changes, provided these do not involve an alteration of the essential features of the invention which are claimed below.

1. A radioactive waste container, suitable for housing a canister or rack (C) containing the waste constituting a source of radioactive emission; characterized in that it comprises:
an inner containment barrier (1) against photon radiation, delimiting a housing for the canister or the rack (C) for the radioactive waste to be stored, and comprising: a cylindrical inner steel ferrule (11), a base (12) and a lid (13);
an outer containment barrier (2) against photon radiation, forming the outer surface of the container (10), and comprising: a cylindrical outer steel ferrule (21), a base (22) and a lid (23), and
an intermediate concrete layer (3) arranged between said inner (11) and outer (21) ferrules, and forming a shield against neutron radiation.

2. The container according to claim 1 characterized in that the inner and outer ferrules (11, 21) are concentric and delimit an intermediate cavity therebetween in which the intermediate concrete layer (3) is housed.

3. The container, according to claim 1, characterized in that the inner ferrule (11), the outer ferrule (21) and the intermediate concrete layer (3), located in the intermediate cavity, have the same or similar thicknesses.

4. The container, according to claim 1, characterized in that the intermediate concrete layer (3) comprises concrete pieces (3a) that have an annular cylinder arc configuration.

5. The container, according to claim 4, characterized in that the concrete pieces (3a) comprise at least one flat end (31).

6. The container, according to claim 4, characterized in that the concrete pieces (3a) comprise at least one tongued or grooved end (32) for coupling with an adjacent concrete piece (3a).

7. The container, according to claim 1, characterized in that the concrete pieces (3) comprise a metal envelope which contacts the inner (11) and outer (21) ferrules, and which forms a thermal heat dissipation bridge therebetween.

8. The container, according to claim 1, characterized in that the intermediate concrete layer (3) is made by a concrete block (3b) as an annular cylinder, formed “in situ” by a mass of concrete poured between the inner (11) and outer (21) ferrules.

9. The container, according to claim 8, characterized in that the inner and outer ferrules (11, 21) comprise on the facing surfaces a metal connectors (11a, 21a) embedded in the concrete piece (3b).

10. The container, according to claim 1, characterized in that the intermediate concrete layer (3) includes in its composition high-efficiency materials in the neutron radiation shielding.

11. The container, according to claim 1, characterized in that the intermediate concrete layer (3) includes in its composition materials with high density and photon shielding ability.

12. The container, according to claim 1, characterized in that the intermediate concrete layer (3) includes in its composition materials with high thermal conductivity and heat dissipation ability.

13. The container, according to claim 1, characterized in that the intermediate concrete layer (3) includes in its composition materials with high mechanical strength.

14. The container, according to claim 1, characterized in that it comprises between the bases (12, 22) and between the lids (13, 23) closing the inner (1) and outer (2) containment barriers at their bottom and top, at least one radiation shielding layer (4, 5), made of: concrete, steel, lead or any other material suitable for radiation shielding.

15. The container, according to claim 1, characterized in that it comprises between the bases (12, 22) and/or between the lids (13, 23) for closing the inner (1) and outer (2) containment barriers, elastic elements (6) for shock absorption.

16. The container, according to claim 1, characterized in that the lids (13, 23) of the inner (1) and outer (2) containment barriers comprise, on their inner face, metal sheets (16), for mounting and seating on the respective inner (11) and outer (21) ferrules.

17. The container according to claim 1, characterized in that it comprises, between the lids (13, 23) and the respective inner (11) and outer (21) ferrules, respective pressure sealing gaskets (18, 26).

18. The container according to claim 1, characterized in that the lids (13, 23) are fixed to the respective inner (11) and outer (21) ferrules by means of bolts (17, 25).
